(19) United States
(12) Patent Application Publication
(10) Pub. No.: US 2026/0012082 A1
(43) Pub. Date: Jan. 8, 2026

(54) POWER SUPPLY DEVICE AND ELECTRONIC DEVICE COMPRISING SAME

(71) Applicant: SAMSUNG ELECTRONICS CO., LTD., Suwon-si (KR)

(72) Inventor: Youngho CHOI

(73) Assignee: SAMSUNG ELECTRONICS CO., LTD., Suwon-si (KR)

(21) Appl. No.: 19/329,134

(22) Filed: Sep. 15, 2025

Related U.S. Application Data
(63) Continuation of application No. PCT/KR2024/001123, filed on Jan. 24, 2024.

(30) Foreign Application Priority Data
Mar. 15, 2023 (KR) 10-2023

(51) Int. Cl. H02M 1/12; G09G 3/20; H02M 1/34; H02M 1/42; H02M 1/44; H02M 7/217; H02M 7/537

(52) U.S. Cl. CPC H02M 1/126; H02M 1/342; H02M 7/217; H02M 7/537; G09G 3/20; G09G 2330/021; H02M 1/4208; H02M 1/44

(57) ABSTRACT

An electronic device includes a power supply device configured to output a high-frequency alternating current through a cable based on an input alternating current; and a display configured to operate based on a direct current obtained from the high-frequency alternating current supplied from the power supply device through the cable. The power supply device includes a balanced type filter configured to pass a high-frequency alternating current having a single frequency from the input alternating current; and a transformer configured to increase a voltage of the high-frequency alternating current and to output the high-frequency alternating current having the increased voltage through the cable. The display includes a transformer configured to reduce the increased voltage to a predetermined level; and a rectifier configured to convert the high-frequency alternating current having the reduced voltage into the direct current of a target level of an operating voltage.

### CROSS-REFERENCE TO RELATED APPLICATION

This application is a by-pass continuation application of International Application No. PCT/KR2024/001123, filed on Jan. 24, 2024 which is based on and claims priority to Korean Patent Application No. 10-2023-0033662, filed on Mar. 15, 2023, in the Korean Intellectual Property Office, the disclosures of which are incorporated by reference herein in their entireties.

### 1. FIELD

The disclosure relates to an electronic device for power transmission between a power supply device and a display using high-frequency alternating current through a cable connection.

### 2. DESCRIPTION OF RELATED ART

With recent advancements in electronic technology, various types of display devices are being developed and distributed, and the demand for large display devices may be increasing.

These large display devices require high power, so that the adapter that supplies power and the display device should be connected by thick cables, and a converter for processing high-power signals in the display device may be mounted. Accordingly, the design and user convenience of the display device may be deteriorated.

To implement a thin cable connecting the adapter to the display device and to reduce the display device's thickness, high output voltage power to the display device may be used. However, this approach may encounter limitations related to stability and manufacturing cost.

To supply the desired low DC voltage from the external adapter to the device, the power line connecting them may need to be thick. Conversely, if the external adapter provides a high voltage (high DC voltage) to allow for a thin power line, reducing the device's thickness may be limited because the device should include a component to convert the DC voltage supplied from the external adapter to the desired voltage level.

### SUMMARY

According to an aspect of the disclosure, an electronic device includes a power supply device configured to output a high-frequency alternating current through a cable based on an input alternating current; and a display configured to operate based on a direct current obtained from the high-frequency alternating current supplied from the power supply device through the cable, wherein the power supply device includes a balanced type filter configured to pass a high-frequency alternating current having a single frequency from the input alternating current; and a first transformer configured to increase a voltage of the high-frequency alternating current that has passed through the balanced type filter and to output the high-frequency alternating current having the increased voltage through the cable, and wherein the display includes a second transformer configured to reduce the increased voltage of the high-frequency alternating current supplied from the cable to a predetermined level, and to output the high-frequency alternating current having the reduced voltage; and a rectifier configured to convert the high-frequency alternating current having the reduced voltage into the direct current of a target level of an operating voltage in an internal circuit.

The electronic device may further include an inverter configured to convert a direct current generated from the input alternating current into an alternating current and to transfer the alternating current to the balanced type filter, wherein the inverter includes a plurality of switching elements connected to be alternately switched.

The electronic device may include wherein the balanced type filter is configured as a notch filter having a time constant based on reactance and capacitance such that a switching frequency for resonance becomes the single frequency.

The electronic device may include wherein the balanced type filter has a symmetrical structure in which a first inductor and a first capacitor are connected in series to have the time constant during a positive cycle of the input alternating current, and a second inductor and a second capacitor are connected in series to have the time constant during a negative cycle of the input alternating current.

The electronic device may include wherein a winding ratio of the first transformer is determined based on a voltage of the high-frequency alternating current to be supplied to the display through the cable, and wherein a winding ratio of the second transformer is determined based on the operating voltage in the internal circuit.

The electronic device may include wherein the power supply further includes an external connector interface, and wherein the cable includes a power line configured to transfer the high-frequency alternating current and a signal line configured to connect the external connector interface.

The electronic device may include wherein the rectifier is configured as a center-tapped rectifier.

According to another aspect of the disclosure, an electronic device includes a power supply device configured to output a high-frequency alternating current through a cable based on an input alternating current; and a display configured to operate based on a direct current obtained from the high-frequency alternating current supplied from the power supply device through the cable, wherein the power supply device includes a balanced type filter configured to pass a high-frequency alternating current having a single frequency from the input alternating current; and a transformer configured to increase a voltage of the high-frequency alternating current that has passed through the balanced type filter and to output the high-frequency alternating current having the increased voltage through the cable, and wherein the display includes a current doubler rectifier configured to double a current of the high-frequency alternating current having the increased voltage supplied from the cable to obtain an operating voltage in an internal circuit.

The electronic device may further include an inverter configured to convert a direct current generated from the input alternating current into an alternating current and to transfer the alternating current to the balanced type filter, wherein the inverter is configured as a phase shift full bridge.

The electronic device may further include a coupled inductor configured to connect to an output end of the balanced type filter and to remove noise generated from the balanced type filter.

The electronic device may include wherein the coupled inductor is configured in a same winding direction.

The electronic device may include wherein the current doubler rectifier further includes at least one inductor disposed to connect an input terminal of the high-frequency alternating current supplied from the cable and a supply end of the operating voltage in series.

The electronic device may include wherein current doubler rectifier further includes a snubber circuit, and wherein the snubber circuit is configured as a lossless active snubber connected to the at least one inductor.

The electronic device may include wherein one end of the snubber circuit is configured to connect to an output end of a switching element, wherein the output end of the switching element is connected to an input end of the inductor, and wherein based on a voltage across the switching element exceeding a threshold level, the snubber circuit is configured to output an electrical signal.

The electronic device may include wherein the power supply device further includes an external connector interface, and wherein the cable includes a power line configured to transfer the high-frequency alternating current and a signal line configured to connect the external connector interface.

### BRIEF DESCRIPTION OF THE DRAWINGS

The above and other aspects, features, and advantages of certain embodiments of the present disclosure are more apparent from the following description taken in conjunction with the accompanying drawings, in which:

FIG. 1 is a block diagram illustrating an electronic device according to an embodiment of the disclosure;

FIG. 2 is a detailed block diagram illustrating an electronic device according to an embodiment of the disclosure;

FIG. 3 is a detailed block diagram illustrating an electronic device according to an embodiment of the disclosure;

FIG. 4 is a circuit diagram illustrating a power supply unit and a power reception unit according to an embodiment of the disclosure;

FIG. 5 is a detailed block diagram illustrating an electronic device according to an embodiment of the disclosure;

FIG. 6 is a circuit diagram illustrating a power supply unit and a power reception unit according to an embodiment of the disclosure;

FIG. 7 is a graph illustrating a voltage over time, measured at a point of an electronic device according to an embodiment of the disclosure;

FIG. 8 is a graph illustrating a voltage and a current over time, measured at a point of an electronic device according to an embodiment of the disclosure over time; and

FIG. 9 is a graph illustrating a voltage over time, measured at a point of an electronic device according to an embodiment of the disclosure.

In connection with the description of the drawings, the same or similar reference numerals may be used to denote the same or similar elements.

### DETAILED DESCRIPTION

The embodiments described in the disclosure, and the configurations shown in the drawings, are only examples of embodiments, and various modifications may be made without departing from the scope and spirit of the disclosure.

According to an embodiment of the disclosure, user convenience may be increased by implementing a reduced thickness of a cable line and a display included in an electronic device.

The technical objects of the disclosure are not limited to the foregoing, and other technical objects may be derived by one of ordinary skill in the art from example embodiments of the disclosure.

Effects of the present invention are not limited to the foregoing, and other unmentioned effects would be apparent to one of ordinary skill in the art from the following description. In other words, unintended effects in practicing embodiments of the disclosure may also be derived by one of ordinary skill in the art from example embodiments of the disclosure.

Embodiments of the present invention are now described with reference to the accompanying drawings in such a detailed manner as to be easily practiced by one of ordinary skill in the art to which the disclosure pertains (hereinafter, referred to as ‘one of ordinary skill in the art’). However, the disclosure may be implemented in other various forms and is not limited to the embodiments set forth herein. The same or similar reference denotations may be used to refer to the same or similar elements throughout the specification and the drawings. Further, for clarity and brevity, no description is made of well-known functions and configurations in the drawings and relevant descriptions.

For use in embodiments of the disclosure, common terms widely used as possible have been chosen considering functions in the disclosure, but the terms may be varied depending on the intent of one of ordinary skill in the art or case laws or the advent of new technologies. Accordingly, the terms used herein should be determined based on their meanings and the overall disclosure, rather than by the terms themselves.

In various embodiments of the disclosure, when an element “includes” another element, the element may further include the other element, rather excluding the other element, unless particularly stated otherwise.

The expressions “at least one of A, B and C” and “at least one of A, B, or C”, both indicate “A”, only “B”, only “C”, both “A and B”, both “A and C”, both “B and C”, and all of “A, B, and C”.

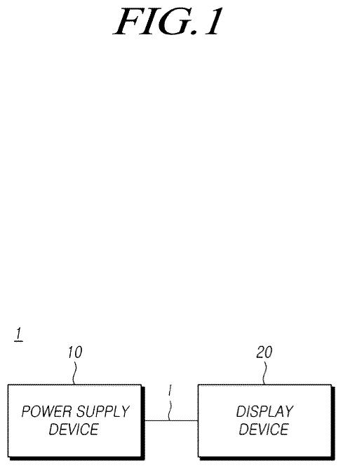

FIG. 1 is a block diagram illustrating an electronic device 1 according to an embodiment of the disclosure.

Referring to FIG. 1, an electronic device 1 may include a power supply device 10 or a display device 20.

According to an example, the electronic device 1 may include various devices that display stored content or execute content stored in the electronic device 1. The electronic device 1 may display content provided through wireless communication.

For example, the electronic device 1 may include a computer, a laptop, or a tablet PC.

For example, the electronic device 1 may include a TV. The TV may include, e.g., a light emitting diode (LED) TV, a quantum dot light emitting diode (QLED) TV, an organic light emitting diode (OLED) TV, or an active matrix organic light emitting diode (AMOLED) TV.

For example, the electronic device 1 may include a monitor. Further, the electronic device 1 may include various devices including a display.

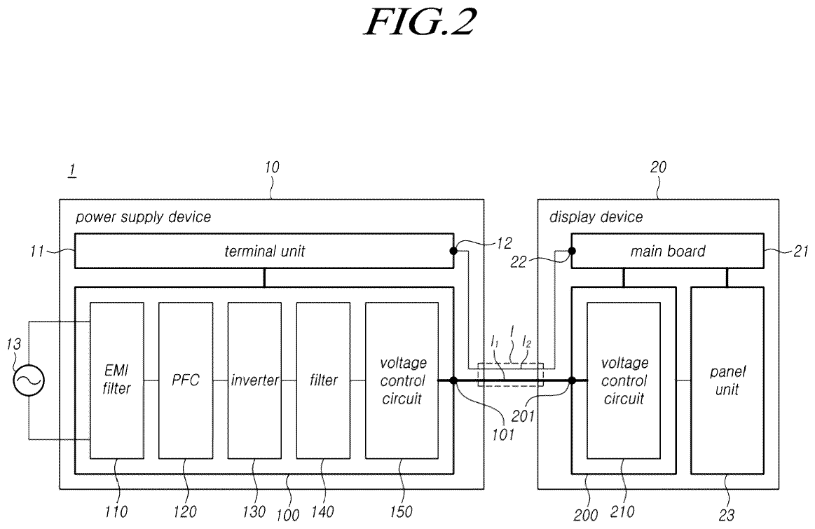

According to an example, the power supply device 10 may be provided to supply power to the electronic device 1. The power supply device 10 may process the supplied external power source (e.g., the external power source 13 of FIG. 2) to output power having a predetermined voltage value to the display device 20.

According to an embodiment, the power supply device 10 may be implemented as a power adapter. The power supply device 10 may supply power and transmit content to the display device 20 like a one connect box (hereinafter referred to as an OC box) does. Here, the content may be content stored in the electronic device 1 or content received from the outside.

According to an example, the power supply device 10 may include a terminal unit (e.g., the terminal unit 11 of FIG. 2) or a power supply unit (e.g., the power supply unit 100 of FIG. 2). For example, the terminal unit 11 may be provided with at least one terminal for connecting the electronic device 1 and an external electronic device.

Although not illustrated, the power supply device 10 may include a speaker and an infrared sensor.

According to an example, as the power supply device 10 is implemented as an OC box, user convenience and/or aesthetics may be enhanced by minimizing cables exposed to the outside of the electronic device 1 by connecting the power supply device 10 and the external electronic device without directly connecting the display device 20 and the external electronic device.

According to an example, the display device 20 may be provided to display content. The display device 20 may receive power required for driving from the power supply device 10.

For example, the display device 20 may receive power from the power supply device 10 and operate with the received power without having a power line for connecting to a power outlet providing commercial power.

For example, the display device 20 may convert the driving power and the standby power received from the power supply device 10 and operate using the converted power.

According to an example, the power supply device 10 and the display device 20 may be connected to each other by a main cable 1. The main cable 1 may physically and/or electrically connect the power supply device 10 and the display device 20. The main cable 1 may be implemented as a one-connect cable (hereinafter referred to as an OC cable). For example, the main cable 1 may include at least one cable (e.g., the first cable 1₁ or the second cable 1₂ of FIG. 2). The first cable 1₁ and the second sub cable 1₂ are described below in detail with reference to FIG. 2.

According to an example, the electric signal processed by the power supply device 10 may be transmitted to the display device 20 through the main cable 1. The thickness of the main cable 1 may be determined according to the strength of current (e.g. current magnitude or current level) or the strength of voltage (e.g. voltage magnitude or voltage level) of the electric signal flowing through the main cable 1. For example, when the current of the electric signal flowing through the main cable 1 is high, the thickness of the main cable 1 may be increased. If the current of the electric signal flowing through the main cable 1 is low, the thickness of the main cable 1 may be decreased. Assuming that the power of the electric signal is constant, the current and voltage of the electric signal are inversely proportional, so in order to keep the thickness of the main cable 1 thin, the current of the electric signal flowing through the main cable 1 should be kept low or the voltage of the electric signal should be kept high.

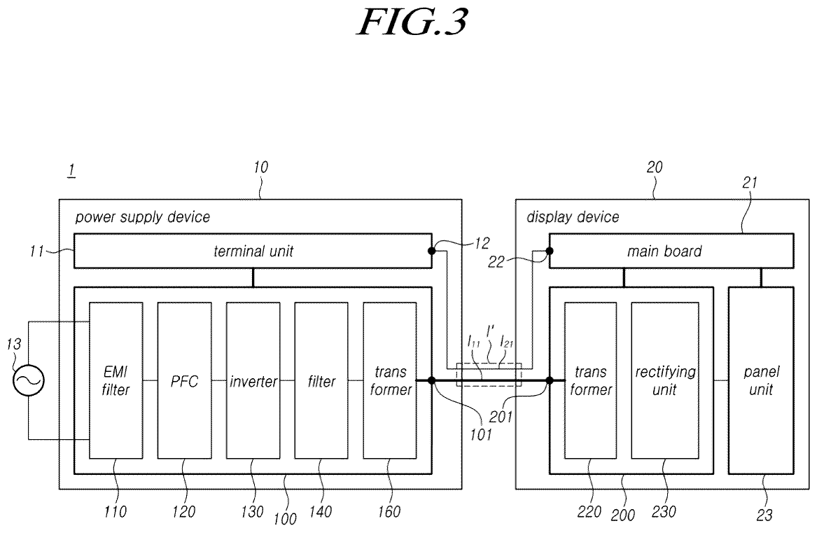

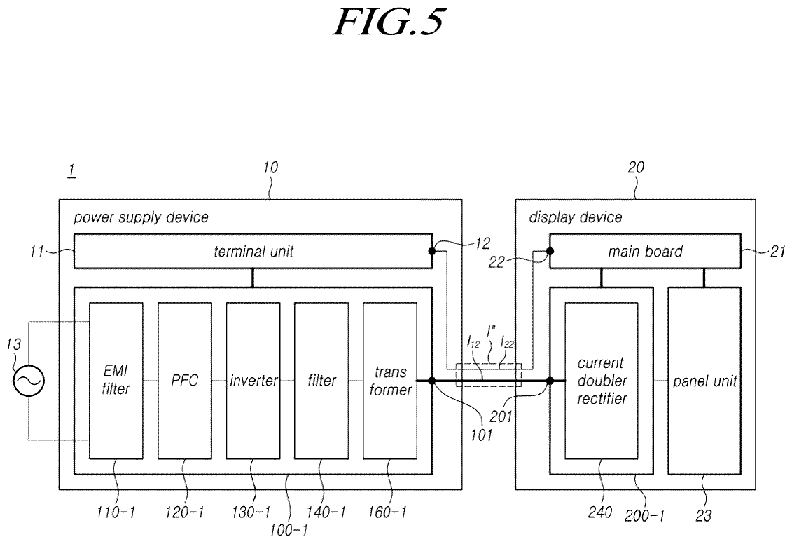

According to an example, the power supply device 10 and the display device 20 may be implemented as a switching mode power supply (hereinafter referred to as SMPS). The power supply device 10 and the display device 20 implemented as the SMPS may adjust the voltage and current of power transmitted and/or received using a high-frequency switching technology. For example, the power supply device 10 and the display device 20 may include a switching element. A detailed circuit configuration of the power supply device 10 and the display device 20 is described in detail with reference to FIG. 3 or 5.

FIG. 2 is a detailed block diagram illustrating an electronic device 1 according to an embodiment of the disclosure.

Referring to FIG. 2, the power supply device 10 may include a terminal unit 11 or a power supply unit 100.

According to an example, the terminal unit 11 may include at least one terminal. The at least one terminal may include at least one of a universal serial bus (USB) port, a high definition multimedia interface (HDMI) port, a display port (DP) port, an Ethernet cable (ethernet cable) port, an optical cable port, a component & audio/video (A/V) cable port, an antenna cable port, or a power cable port.

According to an example, the terminal unit 11 may be implemented integrally with the power supply device 10 or may be implemented independently. Since the terminal unit 11 is integrally implemented with the power supply device 10, user convenience and/or aesthetics may be enhanced.

According to an example, the first interface 12 may be provided on the terminal unit 11. The first interface 12 may be provided to allow a cable connecting the terminal unit 11 and an external device to be inserted therethrough. One end of the second cable 1₂ may be connected to the first interface 12. The other end of the second cable 1₂ may be connected to the second interface 22 of the main board 21 included in the display device 20.

According to an example, the power supply unit 100 may include an electromagnetic interference (EMI) filter 110, a power factor correction (PFC) circuit 120, an inverter circuit 130, a filter circuit 140, or a first voltage control circuit 150. Some of the components may be omitted, or the power supply unit 100 may further include an additional component.

According to an example, the EMI filter 110 may rectify and smooth the input commercial power (e.g., the input power 13) to output a DC power signal of a predetermined level. In the EMI filter 110, a half-wave or full-wave rectification circuit may be used for rectification, and a capacitor may be connected in parallel to the output end of the rectification circuit for smoothing.

According to an example, the PFC circuit 120 may be connected to an output end of the EMI filter 110. The PFC circuit 120 may offset the reactive power (Q) to meet the power factor (PF) standard of the electronic product.

According to an example, the inverter circuit 130 may be connected to the output end of the PFC circuit 120. The inverter circuit 130 may adjust energy transmission between the input signal and the output load. The inverter circuit 130 may protect the circuit against overvoltage, overcurrent, or overheating conditions. For example, the inverter circuit 130 may be implemented as an LLC circuit.

According to an example, the inverter circuit 130 may include a bridge circuit. For example, the bridge circuit may include a half-bridge inverter or a full-bridge inverter. The inverter circuit 130 may convert an electric signal of a DC component into an electric signal of an AC component.

According to an example, the filter circuit 140 may be connected to the output end of the inverter circuit 130. For example, the filter circuit 140 may be implemented as a balanced type filter. Since the filter circuit 140 is implemented as a balanced type filter, EMI that may occur in an electrical signal may be decreased.

According to an example, the filter circuit 140 may be provided to output a high-frequency AC signal of a single frequency. The filter circuit 140 may maintain a reduced thickness of the main cable 1 by outputting a high-frequency AC signal. The high frequency may correspond to, e.g., 100 kHz (kilohertz). However, the disclosure is not limited thereto, and it may be set to various values according to the circuit configuration of the electronic device 1.

For example, the filter circuit 140 may be provided to output a signal having a high frequency. For example, the filter circuit 140 may be implemented as a notch filter or a band pass filter (BPF). The electrical signal passing through the filter circuit 140 may be output as an AC signal having a high-frequency signal.

According to an example, the first voltage control circuit 150 may be connected to the output end of the filter circuit 140. The first voltage control circuit 150 may boost or reduce the input signal to a signal of a preset strength (e.g. a preset voltage). The first voltage control circuit 150 may be implemented as a transformer (e.g., the first transformer 160 of FIG. 3 or the first transformer 160-1 in FIG. 5). The transformer 160, 160-1 has a primary winding and a secondary winding around a core and, if a current change occurs in the primary winding, an induced electromotive force is also generated in the secondary winding due to a change in magnetic flux passing through the core to boost or reduce the induced current to a signal of a preset strength. The voltage ratio between the input signal and the output signal of the transformer 160, 160-1 may be adjusted through the ratio of the primary winding and the secondary winding.

A detailed configuration of the circuitry constituting the power supply unit 100 is described below in detail with reference to FIG. 3.

According to an embodiment, the display device 20 may include a main board 21, a panel unit 23, or a power reception unit 200.

According to an example, the power reception unit 200 may receive power from the power supply device 10 and supply power having a predetermined power to each component (e.g., the main board 21 and/or the panel unit 23) of the display device 20. The power reception unit 200 may include a second voltage control circuit 210.

According to an example, the second voltage control circuit 210 may be connected to the first voltage control circuit 150. The first cable 11 may connect the first voltage control circuit 150 and the second voltage control circuit 210. One end of the first cable 11 may be connected to the third interface 101 provided at the output end of the first voltage control circuit 150. The other end of the first cable 11 may be connected to the fourth interface 201 provided at the input end of the second voltage control circuit 210.

According to an example, the second voltage control circuit 210 may receive a high-frequency AC signal output from the first voltage control circuit 150.

According to an example, the second voltage control circuit 210 may adjust the voltage level of the signal input through the first voltage control circuit 150 to a preset level. For example, the second voltage control circuit 210 may drop the voltage level of the signal output from the first voltage control circuit 150 to a predetermined level.

According to an example, the second voltage control circuit 210 may drop the voltage level of the received high frequency AC signal to a predetermined level. The second voltage control circuit 210 may drop the voltage level by the rated voltage of an electrical component (e.g., the main board 21 or the panel unit 23) included in the display device 20.

According to an example, the second voltage control circuit 210 may convert a high frequency AC signal into a DC signal. To this end, the second voltage control circuit 210 may include a rectifying circuit or a converter circuit. The rectifying circuit may be implemented as, e.g., a synchronous rectifier (SR).

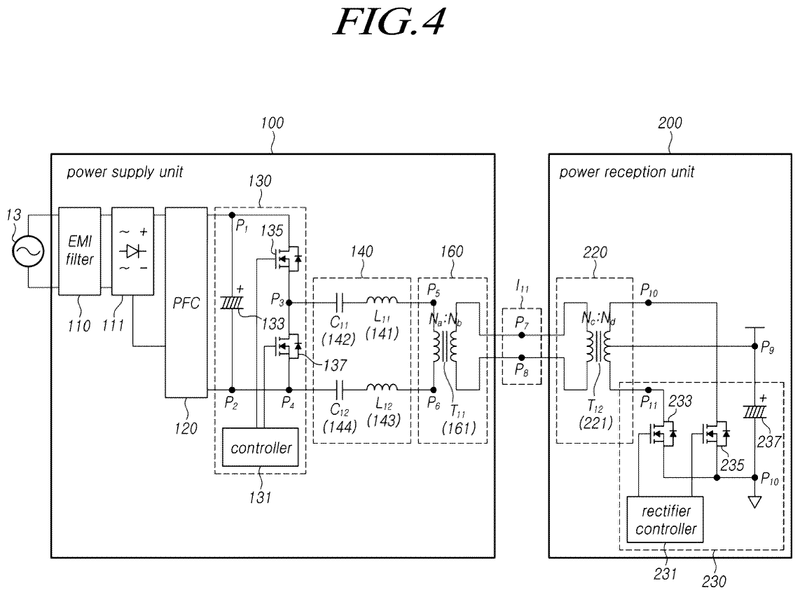

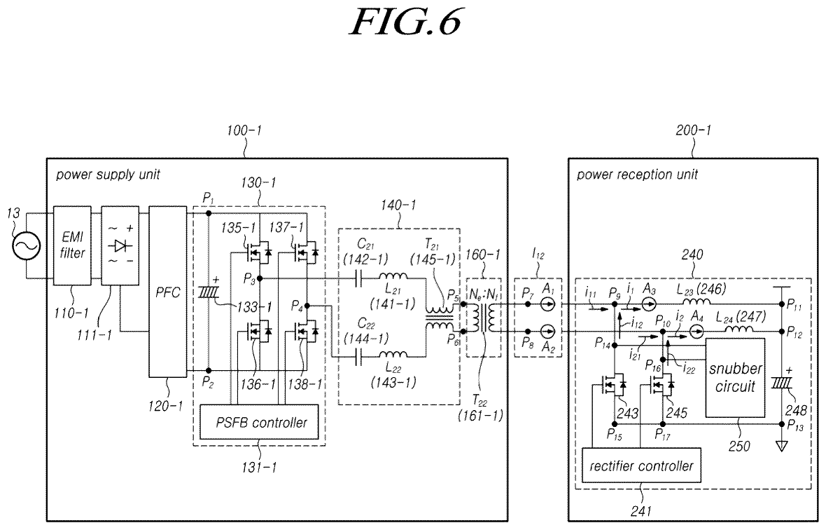

According to an example, the second voltage control circuit 210 may be implemented as a transformer (e.g., the second transformer 220 of FIG. 3) or a current doubler rectifier (e.g., the current doubler rectifier 240 of FIG. 5). Hereinafter, a detailed circuit structure is described with reference to FIG. 4 or FIG. 6.

According to an example, the first voltage control circuit 150 may output a signal having a preset voltage. The power may be input or supplied to the second voltage control circuit 210 through the first cable 11. The thickness of the first cable 1₁ may be determined according to the strength of current or the strength of voltage of the signal flowing through the first cable 1₁.

For example, in order to implement a reduced thickness of the first cable 1₁, the voltage level of the high-frequency signal output to the first voltage control circuit 150 may be set to be high. In order to set the voltage level of the signal to be high, the winding ratio of the transformer included in the first voltage control circuit 150 may be set to a predetermined ratio. The second voltage control circuit 210 may drop the voltage level of the signal output from the first voltage control circuit 210 by a predetermined ratio. The second voltage control circuit 210 may drop the voltage of the signal by a predetermined ratio for transmission to the electrical component (e.g., the main board 21 or the panel unit 23) provided in the display device 20.

For example, when the second voltage control circuit (210) is implemented as the transformer (220), the electric signal may be dropped by adjusting the ratio of the primary and secondary windings constituting the transformer above (220).

For example, when the second voltage control circuit 210 is implemented as the current doubler rectifier 240, the current doubler rectifier above 240 may reduce the voltage by amplifying the current of the input signal by a preset ratio.

According to an example, the first voltage control circuit 150 and the second voltage control circuit 210 may provide a reduced thickness of the power supply device 10 or the display device 20 by controlling the voltage level of the high-frequency AC signal without a separate component (e.g., a DC-DC converter).

According to an example, by controlling the voltage level of the high-frequency AC signal, the first voltage control circuit 150 and the second voltage control circuit 210 may provide a reduced total thickness of the main cable 1.

FIG. 3 is a detailed block diagram illustrating an electronic device 1 according to an embodiment of the disclosure.

Referring to FIG. 3, the first voltage control circuit (e.g., the first voltage control circuit 150 of FIG. 2) is implemented as the first transformer 160, and the second voltage control circuit (e.g., the second voltage control circuit 210 of FIG. 2) is implemented as the transformer 220 and the rectifying unit 230. Therefore, the description overlapping with FIG. 2 is omitted, and the focus is primarily on illustrating the differences.

According to an embodiment, the terminal unit 11 and the main board 21 may be connected to each other by a cable 2-1 1₂₁. One end of the cable 2-1 1₂₁ may be connected to the first interface 12 of the terminal unit 11. The other end of the cable 2-1 1₂₁ may be connected to the second interface 22 of the main board 21.

According to an example, the first voltage control circuit 150 of FIG. 2 may be implemented as a first transformer 160. The electric signal output by the first transformer 160 may be transferred to the power reception unit 200 through the cable 1-1 1₁₁. One end of the cable 1-1 1₁₁ may be connected to the third interface 101 provided in the power supply unit 100. The other end of the cable 1-1 1₁₁ may be connected to the fourth interface 201 provided in the power reception unit 200.

According to an example, since the voltage control circuit 150 is implemented as the first transformer 160, the voltage of the high-frequency signal to be transferred to the display device 20 may be amplified according to the ratio of the primary and secondary windings constituting the first transformer 160. Since the voltage control circuit 150 is implemented as the first transformer 160, the voltage of the high-frequency signal to be transferred to the display device 20 may be maintained high. For this reason, the thickness of the cable 1-1 1₁₁ may be kept thin. Therefore, the overall thickness of the OC cable 1 may be decreased.

According to an example, the high-frequency signal transmitted from the first transformer 160 may be transferred to the second transformer 220. According to the ratio of the primary and secondary windings constituting the second transformer 220, the voltage of the transmitted high-frequency signal may be dropped to a preset voltage value. The second transformer 160 may output a voltage corresponding to the rated voltage of an electrical component (e.g., the main board 21 or the panel unit 23) included in the display device 20. The electrical signal processed by the second transformer 220 may be transferred to the rectifying unit 230. The rectifying unit 230 may rectify the high-frequency AC signal output from the second transformer 220 into a DC signal and output the DC signal. The output DC signal may be transferred to the main board 21 or the panel unit 23 included in the display device 20.

According to an example, the second transformer 220 may be implemented as a plurality of transformers. By implementing the second transformer 220 as a plurality of transformers, an electric signal having a preset voltage may be transmitted to an electric component (e.g., a main board 21 and a panel unit 23) included in the display device 20.

According to an example, the rectifying unit 230 may convert the high-frequency signal of alternating current transferred from the second transformer 220 into a direct current electric signal. For example, the rectifying unit 230 may be implemented in the form of a converter circuit. The rectifying unit 230 may include, e.g., a synchronous rectifier. For example, the rectifying unit 230 may include at least one switching element (e.g., the switching elements 233 and 235 of FIG. 4) and a controller (the rectifier controller 231 of FIG. 4).

According to an example, the direct current electric signal passing through the rectifying unit 230 may be transferred to each of the electric components included in the display device 20.

According to an example, the first transformer 160 and the second transformer 220 may provide a reduced thickness of the power supply device 10 or the display device 20 by controlling the voltage level of the high-frequency AC signal without separately providing a component (e.g., a DC-DC converter) for adjusting the voltage of the DC signal.

According to an example, the first transformer 160 and the second transformer 220 may control the voltage level of the high-frequency AC signal to provide a reduced total thickness of the OC cable 1′.

FIG. 4 is a circuit diagram illustrating a power supply unit (e.g., a power supply unit 100 of FIG. 2) and a power reception unit (e.g., a power reception unit 200 of FIG. 2) according to an embodiment of the disclosure.

Referring to FIG. 4, the power supply unit 100 may include an EMI filter 110, a bridge diode 111, a PFC circuit 120, an inverter circuit 130, a filter circuit 140, or a first transformer 160.

According to an embodiment, the power reception unit 200 may include a second transformer 220 or a rectifying unit 230.

According to an embodiment, the EMI filter 110 may be connected to a commercial power source 13.

According to an embodiment, the bridge diode 111 may be connected to one end of the EMI filter 110. The bridge diode 111 may convert the electric signal of the alternating current AC input to the commercial power source 13 into the direct current (DC) electric signal.

According to an embodiment, the PFC circuit 120 may be connected to one end of the bridge diode 111.

According to an example, the inverter circuit 130 may be connected to one end of the PFC circuit 120.

According to an example, the inverter circuit 130 may include an inverter controller 131, a first electrolytic capacitor 133, a switching element 1-1 135, or a switching element 1-2 137.

For example, the inverter controller 131 may be implemented as an LLC controller. The inverter controller 131 may control a switch-on and a switch-off of the switching element 1-1 135 or the switching element 1-2 137. One end of the inverter controller 131 may be connected to the respective gate ends of the switching elements 135 and 137. For example, one end of the inverter controller 131 may be connected to the gate end of the switching element 1-1 135. The other end of the inverter controller 131 may be connected to the gate end of the switching element 1-2 137.

For example, the first electrolytic capacitor 133 may be connected in parallel with the PFC circuit 120. The first electrolytic capacitor 133 may be provided to allow a high-frequency signal to pass through the electric signal output through the PFC circuit 120 or to store energy to be supplied to some electrical elements.

For example, the switching device 1-1 135 and the switching device 1-2 137 may constitute a half-bridge inverter. The half-bridge inverter may convert a DC electric signal into an AC electric signal. The half-bridge inverter may control the duty ratio. For example, the half-bridge inverter may control the duty ratio to 0.5 to reduce the output voltage to ½ of the input voltage.

According to an example, the filter circuit 140 may include at least one inductor (L) 141, 143 or at least one capacitor (C) 142, 144.

As an example, at least one inductor 141, 143 may include an inductor 1-1 141 or an inductor 1-2 143. The inductance value of the inductor 1-1 141 may be defined as L₁₁. The inductance value of the inductor 1-2 143 may be defined as L₁₂. The inductor 1-1 141 and the inductor 1-2 143 may have the same inductance value or different inductance values. In other words, L₁₁ and L₁₂ may or may not be the same.

For example, the at least one capacitor 142 and 144 may include a capacitor 1-1 142 or a capacitor 1-2 144. The capacitance value of the capacitor 1-1 142 may be defined as C₁₁. The capacitance value of the capacitor 1-2 144 may be defined as C₁₂. The capacitor 1-1 142 and the capacitor 1-2 144 may have the same capacitance value or different capacitance values. In other words, C₁₁ and C₁₂ may or may not be the same.

According to an embodiment, the filter circuit 140 may be implemented as a balanced type filter. Here, the balanced type filter may refer to a filter circuit in which filters composed of the same passive electrical elements (e.g., a resistor R, an inductor L, or a capacitor C) are connected in parallel. The balanced type filter may reduce EMI that may occur due to transmission of the AC signal by the filter circuit 140. The time constant of the inductor 141, 143 and the capacitor 142, 144 constituting the filter circuit 140 may be configured to resonate at the switching frequency. For this reason, the filter circuit 140 may reduce EMI due to harmonics because the AC signal may pass only the high-frequency AC signal with the corresponding resonance frequency.

For example, the inductor 1-1 141 and the capacitor 1-1 142 connected in series may be connected in parallel to the inductor 1-2 143 and the capacitor 1-2 144. Any point P₃ between the source end of the switching element 1-1 135 and the drain end of the switching element 1-2 137 may be connected to the capacitor 1-1 141. The source end P₄ of the switching element 1-2 137 may be connected to the capacitor 1-2 143.

According to an example, the filter circuit 140 may output a high-frequency signal. The high-frequency signal may correspond to, e.g., 100 kHz. However, the disclosure is not limited thereto, and it may be set to various values according to the circuit configuration of the electronic device 1. For example, the resonance frequency f of the filter circuit 140 may be determined by f=½π(L*C)^{1/2}.

According to an example, the first transformer 160 may be connected to the front end of the filter circuit 140. The first transformer 160 may be composed of the transformer 1-1 161. The number of turns of the primary winding of the transformer 1-1 161 may be defined as Nₐ, and the number of turns of the secondary winding may be defined as N_{b}. The number Nₐ of turns of the primary winding may have a value smaller than that of the number N_{b} of turns of the secondary winding.

According to an embodiment, the transformer 1-1 161 may convert the voltage at a preset ratio. The preset ratio may be determined by the number Nₐ of turns of the primary winding and the number N_{b} of turns of the secondary winding of the transformer 1-1 161. For example, if the voltage of the electrical signal input to the transformer 1-1 161 is V₁, the voltage V₂ of the electrical signal output from the transformer 1-1 161 may be defined as V₂=V₁*N_{b}/Nₐ. The voltage of the electrical signal output from the transformer 1-1 161 may be boosted and output to a value larger than the voltage of the electrical signal input to the transformer 1-1 161.

According to an example, as the transformer 1-1 161 outputs a high-voltage high-frequency signal, the thickness of the cable 1-1 1₁₁ may be decreased. By maintaining a reduced thickness of the cable 1-1 1₁₁, an OC cable (e.g., the OC cable 1′ of FIG. 3) may be reduced.

According to an embodiment, the second transformer 220 may include a transformer 1-2 221. The transformer 1-2 221 may be connected to the output end of the filter circuit 140. The number of turns of the primary winding of the transformer 1-2 221 may be defined as N_{c}, and the number of turns of the secondary winding may be defined as N_{d}. The number N_{c} of turns of the primary winding may have a value larger than the number N_{d} of turns of the secondary winding.

According to an embodiment, the transformer 1-2 221 may convert the voltage at a preset ratio. The preset ratio may be determined by the number Nₐ of turns of the primary winding and the number N_{b} of turns of the secondary winding of the transformer 1-2 221. For example, if the voltage of the electrical signal input to the transformer 1-2 221 is V₃, the voltage V₄ of the electrical signal output from the transformer 1-2 221 may be defined as V₄=V₃*Nₐ/N_{c}. The voltage of the electric signal output from the transformer 1-2 221 may be decreased to a value smaller than the voltage of the electric signal input to the transformer 1-2 221 and output.

According to an embodiment, the second transformer 220 may further include a transformer in addition to the transformer 1-2 221. Since the second transformer 220 is formed of a plurality of transformers, an electric signal having a predetermined voltage may be transmitted to each electrical component included in the display device (e.g., the display device 20 of FIG. 1).

According to an embodiment, the rectifying unit 230 may include a rectifier controller 231, a switching element 233, 235, or an electrolytic condenser 237. The rectifying unit 230 may rectify an AC signal output from the second transformer 220 into a DC signal.

According to an embodiment, the switching element 233, 235 may include at least one switching element 233 and 235. The switching element 233, 235 may be implemented as a field effect transistor (FET) or a metal oxide semiconductor field effect transistor (MOSFET). The at least one switching element 233, 235 may include a switching element 1-3 233 or a switching element 1-4 235.

According to an embodiment, the rectifier controller 231 may be implemented as a synchronous rectifier (SR). The rectifier controller 231 may control the switching element 233, 235 to be switched on or off. The rectifier controller 231 may be connected to each gate end of the switching element 233, 235. For example, one end of the rectifier controller 231 may be connected to the gate end of the switching element 1-3 233. The other end of the rectifier controller 231 may be connected to the gate end of the switching element 1-4 235.

According to an embodiment, the second transformer 220 and the rectifying unit 230 may be implemented as a center-taped rectifier.

According to an embodiment, one end of the secondary winding of the transformer 1-2 221 may be connected to the drain end of the switching element 1-3 233. The other end of the secondary winding may be connected to the drain end of the switching element 1-4 235. Any point of the secondary winding may be connected to one end of the electrolytic condenser 237. The other end of the electrolytic condenser 237 may be connected to a ground terminal.

According to an example, the first transformer 160 and the second transformer 220 may provide a reduced thickness of the power supply device 10 or the display device 20 by controlling the voltage level of the high-frequency AC signal without separately providing a component (e.g., a DC-DC converter) for adjusting the voltage of the DC signal.

According to an example, the first transformer 160 and the second transformer 220 may control the voltage level of the high-frequency AC signal to provide a reduced total thickness of the OC cable (e.g., the OC cable 1′ of FIG. 3).

FIG. 5 is a detailed block diagram illustrating an electronic device 1 according to an embodiment of the disclosure.

Referring to FIG. 5, the first voltage control circuit (e.g., the first voltage control circuit 150 of FIG. 2) is implemented as the first transformer 160-1, and the second voltage control circuit (e.g., the second voltage control circuit 210 of FIG. 2) is implemented as the current doubler rectifier 240. Therefore, the description overlapping with FIG. 2 is omitted, and the focus is primarily on illustrating the differences.

According to an embodiment, the power supply device 10 may include a terminal unit 11 or a power supply unit 100-1. The power supply unit 100-1 may entirely or partially correspond to the power supply unit 100 of FIG. 3.

According to an embodiment, the power supply unit 100-1 may include an EMI filter 110-1, a PFC circuit 120-1, an inverter circuit 130-1, a filter circuit 140-1, or a first transformer 160-1. The EMI filter 110-1 may entirely or partially correspond to the EMI filter 110 of FIG. 3. The PFC circuit 120-1 may entirely or partially correspond to the PFC circuit 120 of FIG. 3. The inverter circuit 130-1 may entirely or partially correspond to the inverter circuit 130 of FIG. 3. The filter circuit 140-1 may entirely or partially correspond to the filter circuit 140 of FIG. 3. The first transformer 160-1 may entirely or partially correspond to the first transformer 160 of FIG. 3.

According to an embodiment, the display device 20 may include a main board 21, a power reception unit 200-1, or a panel unit 23. The power reception unit 200-1 may entirely or partially correspond to the power reception unit 200 of FIG. 2. The power reception unit 200-1 may include a current doubler rectifier 240.

According to an embodiment, the terminal unit 11 and the main board 21 may be connected to each other by a cable 2-2 1₂₂. One end of the cable 2-2 1₂₂ may be connected to the first interface 12 of the terminal unit 11. The other end of the cable 2-2 1₂₁ may be connected to the second interface 22 of the main board 21.

According to an embodiment, the voltage control circuit 150 of FIG. 2 may be implemented as a first transformer 160-1. The high-frequency signal output by the first transformer 160-1 may be transferred to the power reception unit 200 through the cable 1-2 1₁₂. One end of the cable 1-2 1₁₂ may be connected to the third interface 101 provided in the power supply unit 100. The other end of the cable 1-2 1₁₂ may be connected to the fourth interface 201 provided in the power reception unit 200.

According to an example, since the voltage control circuit 150 of FIG. 2 is implemented as the first transformer 160-1, the voltage of the high-frequency signal to be transferred to the display device 20 may be amplified according to the ratio of the primary and secondary windings constituting the first transformer 160-1. Since the voltage control circuit 150 is implemented as the first transformer 160-1, the voltage of the high-frequency signal to be transferred to the display device 20 may be maintained high. For this reason, the thickness of the cable 1-2 1₁₂ may be kept thin. Therefore, the overall thickness of the OC cable 1″ may be decreased.

According to an example, the electric signal transferred from the first transformer 160-1 may be transferred to the current doubler rectifier 240. The current doubler rectifier 240 may drop the voltage of the transmitted high-frequency signal to a preset voltage value.

According to an embodiment, the current doubler rectifier 240 may include at least one inductor. The voltage of the high-frequency signal transmitted from the power supply unit 100-1 may be adjusted through the at least one inductor. For example, the current doubler rectifier 240 may reduce the voltage of the transmitted high-frequency signal to a preset value. The current doubler rectifier 240 may drop the voltage of the transmitted high-frequency signal by the rated voltage of the main board 21 or the panel unit 23 included in the display device 20.

According to an embodiment, the current doubler rectifier 240 may include a rectifying circuit. The rectifying circuit may convert the high frequency AC signal adjusted by the current doubler rectifier 240 into a DC signal. The rectifying circuit may be implemented as, e.g., a converter circuit. The rectifying circuit may include, e.g., a synchronous rectifier.

According to an example, the first transformer 160-1 and the current doubler rectifier 240 may control the voltage level of the high-frequency AC signal without a separate component (e.g., a DC-DC converter) for adjusting the voltage of the DC signal, thereby providing a reduced thickness of the power supply device 10 or the display device 20.

According to an example, the first transformer 160-1 and the current doubler rectifier 240 may control the voltage level of the high-frequency AC signal, thereby providing a reduced total thickness of the OC cable 1″.

According to an example, the electrical signal passing through the current doubler rectifier 240 may be transferred to each of the electrical components (e.g., the main board 21 or the panel unit 23) included in the display device 20.

FIG. 6 is a circuit diagram illustrating a power supply unit (e.g., the power supply unit 100-1 of FIG. 5) and a power reception unit (e.g., the power reception unit 200-1 of FIG. 5) according to an embodiment of the disclosure.

Referring to FIG. 6, since it entirely or partially corresponds to the circuit diagram of FIG. 4, overlapping descriptions are omitted, and the description will focus primarily on the differences.

According to an embodiment, the inverter circuit 130-1 may be connected to one end of the PFC circuit 120-1. The inverter circuit 130-1 may include an inverter controller 131-1, an electrolytic capacitor 133-1, or at least one switching element 135-1, 136-1, 137-1, and 138-1. The at least one switching element may include a switching element 2-1 135-1, a switching element 2-2 136-1, a switching element 2-3 137-1, or a switching element 2-4 138-1.

According to an example, at least one switching element 135-1, 136-1, 137-1, and 138-1 may constitute a phase shift full bridge inverter (hereinafter referred to as a PSFB inverter). The PSFB inverter may convert a direct current electric signal into an alternating current electric signal. The PSFB inverter may control the duty ratio. The duty ratio of the PSFB converter may be set to, e.g., 0.5.

According to an example, the inverter controller 131-1 may be implemented as a phase shift full bridge controller (hereinafter referred to as a PSFB controller). The inverter controller 131-1 may control a switch-on or off of at least one switching element 135-1, 136-1, 137-1, and 138-1. The output end of the inverter controller 131-1 may be connected to the respective gate ends of the switching elements 135-1, 136-1, 137-1, and 138-1.

According to an embodiment, the filter circuit 140-1 may be connected to one end of the inverter circuit 130-1. The filter circuit 140-1 may include at least one inductor 141-1 and 143-1, the at least one capacitor 142-1 and 144-1, or a transformer 2-1 145-1. The at least one inductor 141-1 and 143-1 may include an inductor 2-1 141-1 or an inductor 2-2 143-1. The at least one capacitor 142-1 and 144-1 may include a capacitor 2-1 142-1 or a capacitor 2-2 144-1. The inductance value of the inductor 2-1 141-1 may be defined as L₂₁. The inductance value of the inductor 2-2 143-1 may be defined as L₂₂. The capacitance value of the capacitor 2-1 142-1 may be defined as C₂₁. The capacitance value of the capacitor 2-2 144-1 may be defined as C₂₂. For example, the inductor 2-1 141-1 and the inductor 2-2 143-1 may have the same inductance value or different inductance values. In other words, L₂₁ and L₂₂ may or may not be the same. For example, the capacitor 2-1 142-1 and the capacitor 2-2 144-1 may have the same capacitance value or different capacitance values. In other words, C₂₁ and C₂₂ may or may not be the same.

According to an embodiment, the filter circuit 140-1 may include a balanced type filter and a common mode filter.

According to an embodiment, the balanced type filter may be implemented as at least one inductor 141-1 and 143-1 and at least one capacitor 142-1 and 144-1. The balanced type filter may reduce EMI due to the harmonic component of the AC signal.

For example, the balanced type filter may be configured by connecting, in parallel, the inductor 2-1 141-1 and the capacitor 2-1 142-1 connected in series and the inductor 2-2 143-1 and the capacitor 2-2 144-1 connected in series.

According to an embodiment, the common mode filter may be implemented as at least one capacitor 142-1 and 144-1 and a transformer 2-1 145-1. The common mode filter may remove common mode noise generated due to the common mode.

For example, the common mode filter may be configured by connecting the capacitor 2-1 142-1 and the capacitor 2-2 144-1 connected in parallel, and the transformer 2-1 145-1 in series. The transformer 2-1 145-1 may be wound in the same direction.

According to an embodiment, the filter circuit 140-1 may output a high-frequency signal. The high-frequency signal or the single frequency may correspond to, e.g., 100 kHz. However, the disclosure is not limited thereto, and it may be set to various values according to the circuit configuration of the electronic device 1. For example, the resonance frequency f of the filter circuit 140-1 may be determined by f=½π(L*C)^{1/2}.

According to an example, the first transformer 160-1 may be connected to the front end of the filter circuit 140-1. The first transformer 160-1 may be composed of the transformer 2-2 161-1. The number of turns of the primary winding of the transformer 2-2 161-1 may be defined as Nₑ and the number of turns of the secondary winding may be defined as N_{f}. The number Nₑ of turns of the primary winding may have a value smaller than that of the number N_{f} of turns of the secondary winding.

According to an embodiment, the transformer 2-2 161-1 may convert the voltage at a preset ratio. The preset ratio may be determined by the number Nₑ of turns of the primary winding and the number N_{f} of turns of the secondary winding of the transformer 2-2 161-1. For example, if the voltage of the high-frequency signal input to the transformer 2-2 161-1 is V₅, the voltage V₆ of the high-frequency signal output from the transformer 2-2 161-1 may be defined as V₆=V₅*N_{f}/Nₑ. The voltage of the high-frequency signal output from the transformer 2-2 161-1 may be boosted and output to a value larger than the voltage of the signal input to the transformer 2-2 161-1.

According to an example, as the transformer 2-2 161-1 outputs a high-voltage high-frequency signal, the thickness of the cable 1-2 1₁₂ may be decreased. By maintaining a reduced thickness of the cable 1-2 1₁₂, an OC cable (e.g., the OC cable 1″ of FIG. 5) may be reduced.

According to an example, the current doubler rectifier 240 may include a rectifier controller 241, switching elements 243 and 245, at least one inductor 246, 247, an electrolytic capacitor 248, or a snubber circuit 250.

According to an example, the current doubler rectifier 240 excludes the transformer (e.g., the transformer 1-2 221 of FIG. 4) compared to FIG. 4, and may adjust the voltage by at least one inductor 246, 247. As the current doubler rectifier 240 adjusts the voltage by the at least one inductor 246, 247, the overall thickness of the display device 20 may be reduced as compared with when a transformer is applied.

According to an embodiment, the at least one inductor 246, the 247 may include an inductor 2-3 246 or an inductor 2-4 247. The at least one inductor 246 and 247 may amplify the current of the alternating current electrical signal transmitted from the transformer 2-2 161-1 to a preset value. As the at least one inductor 246 and 247 amplifies the current of the electric signal, the voltage value of the electric signal may be dropped.

According to an embodiment, the switching elements 243 and 245 may include at least one switching element 243, 245. The switching element 243, 245 may be implemented with a field effect transistor (FET) or a metal oxide semiconductor field effect transistor (MOSFET). The at least one switching element 243, 245 may include a switching element 2-5 243 or a switching element 2-6 245.

According to an example, the rectifier controller 241 may be implemented as a synchronous rectifier. The rectifier controller 241 may control the switching element 243, 245 to be switched on or off. The rectifier controller 241 may be connected to each gate end of the switching element 243, 245. For example, one end of the rectifier controller 241 may be connected to the gate end of the switching element 2-5 243. The other end of the rectifier controller 241 may be connected to the gate end of the switching element 2-6 245.

According to an example, the snubber circuit 250 may be implemented as a lossless active snubber circuit. The snubber circuit 250 may be provided to offset an increase in inductance component as the length of the conducting line constituting the circuit increases. For example, the snubber circuit 250 may include a passive element such as a capacitor.

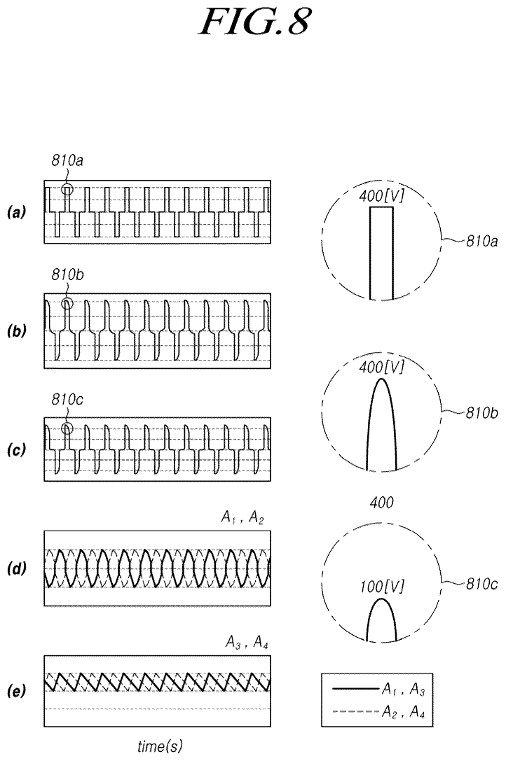

According to an example, the snubber circuit 250 may remove a ringing phenomenon caused by mutual resonance with the parasitic capacitor component of the drain end and the source end of the switching element 243, 245. The snubber circuit 250 may operate when the voltage between two opposite ends of the switching element 243, 245 exceeds a threshold. The waveform diagram illustrating that the ringing phenomenon occurring in the switching element 243, 245 is removed due to the snubber circuit 250 is described in detail in FIG. 8.

According to an example, the electrolytic condenser 248 may be provided to adjust the allowable capacity of the display device 20.

According to an example, the input end P₉ of the inductor 2-3 246 may be connected to the drain end P₁₄ of the switching element 2-5 243. The drain end P₁₄ may be connected to one end of the snubber circuit 250.

According to an example, the input end P₁₀ of the inductor 2-4 247 may be connected to the drain end P₁₆ of the switching element 2-6 245. The drain end P₁₆ may be connected to the other end of the snubber circuit 250.

According to an example, the input end of the electrolytic condenser 248 may be connected to the output end P₁₁ of the inductor 2-3 246 and the output end P₁₂ of the inductor 2-4 247. The output end P₁₃ of the electrolytic condenser 248 may be connected to the source end P₁₅ of the switching element 2-5 243 and the source end P₁₇ of the switching element 2-6 245.

The circuit configuration of the power supply unit 100, 100-1 and the circuit configuration of the power reception unit 200, 200-1 described in connection with FIG. 4 or 6 may be variously configured in addition to those illustrated.

For example, the circuit of the power supply unit 100 of FIG. 4 may be applied as the circuit of the power supply unit 100-1 of FIG. 6.

For example, the circuit of the power reception unit 200 of FIG. 4 may be applied as the circuit of the power reception unit 200-1 of FIG. 6.

For example, the circuit of the power supply unit 100-1 of FIG. 6 may be applied as the circuit of the power supply unit 100 of FIG. 4.

For example, the circuit of the power reception unit 200-1 of FIG. 6 may be applied as the circuit of the power reception unit 200 of FIG. 4.

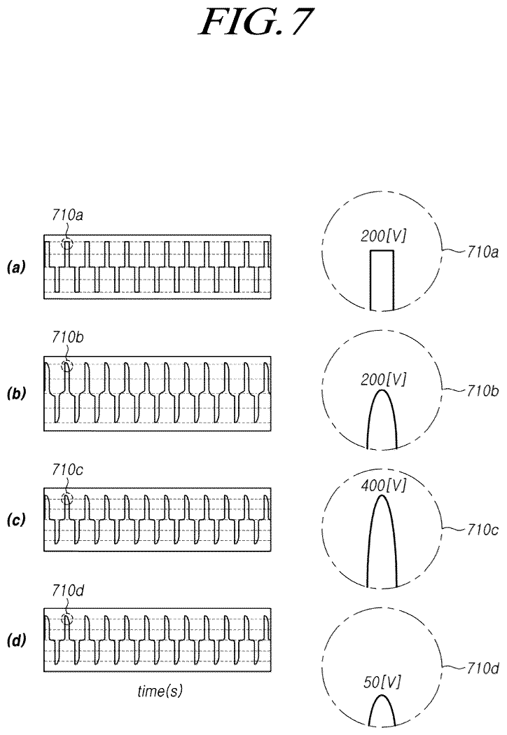

FIG. 7 is a graph illustrating a voltage measured, over time, at a point of an electronic device 1 (e.g., the electronic device 1 of FIG. 3) according to an embodiment of the disclosure.

FIG. 7 illustrates a graph (a) showing the voltage V₃₋₄ between the points P₃ and P₄ in the power supply unit 100 of FIG. 4, a graph (b) showing the voltage V₅₋₆ between the points P₅ and P₆, a graph (c) showing the voltage V₇₋₈ between the points P₇ and P₈, and a graph (d) showing the voltage V₁₀₋₁₁ between the points P₁₀ and P₁₁ in the power reception unit 200 of FIG. 4. The unit of the shown voltage value is V (volt), and the shown value is merely an example for convenience of description, and may vary according to the type of electrical component applied to the electronic device 1.

According to an example, (a) is a graph illustrating the voltage over time before passing through a filter circuit (e.g., the filter circuit 140 of FIG. 4). The maximum value of the voltage value of the electrical signal input to the filter circuit 140 may be, e.g., 200V. The waveform of the voltage may be a signal in which AC signals having a plurality of frequencies overlap. As a result, if the vicinity of the peak 710a of the waveform is enlarged, the waveform may not appear as a complete sine wave.

According to an example, (b) is a graph illustrating the voltage over time after the electrical signal having the waveform (a) passes through the filter circuit 140. The maximum value of the voltage value of the electrical signal output from the filter circuit 140 may be, e.g., 200V. The electrical signal passing through the filter circuit 140 may be a signal that is an AC signal having one frequency. The AC signal passing through the filter circuit 140 may be an AC signal having a high frequency (e.g., 100 kHz). Thus, if the peak vicinity 710b of the waveform is enlarged, the waveform may appear in the form of a sinusoidal wave. The electrical signal having the waveform of (b) may be input to the transformer 1-1 (e.g., the transformer 1-1 161 of FIG. 4). By providing the filter circuit 140, it is possible to reduce EMI generated from the alternating current electric signal.

According to an example, (c) is a graph illustrating the voltage over time after an electrical signal having a waveform of (b) passes through the transformer 1-1 161. If the vicinity 710c of the peak of the waveform is enlarged, the waveform may appear in the form of a sinusoidal wave. The maximum value of the voltage value of the high-frequency signal output from the transformer 1-1 161 may be, e.g., 400V. The maximum value may be derived through the ratio of the number Nₐ of turns of the primary winding and the number N_{b} of turns of the secondary winding of the transformer 1-1 161. For example, when Nₐ:N_{b} is 1:2, the maximum value of the voltage value of the high-frequency signal output from the transformer 1-1 161 may be 400V. The high-frequency signal output from the transformer 1-1 161 may be transferred to the transformer 1-2 221 of the power reception unit 200. As the voltage of the high-frequency signal output by the transformer 1-1 161 increases, the thickness of the cable 1-1 (e.g., the cable 1-1 1₁₁ of FIG. 4) may be maintained thinner. As a result, the thickness of the OC cable (e.g., the OC cable 1′ of FIG. 3) may be decreased.

According to an example, (d) is a graph illustrating the voltage over time after the electrical signal having the waveform of (c) passes through the transformer 1-2 221. If the vicinity 710d of the peak of the waveform is enlarged, the waveform may appear in the form of a sinusoidal wave. The maximum value of the voltage value of the high-frequency signal output from the transformer 1-2 221 may be, e.g., 50V. The maximum value may be derived through the ratio of the number Nₑ of turns of the primary winding and the number Nₐ of turns of the secondary winding of the transformer 1-2 221. For example, when Nₐ:N_{b} is 8:1, the maximum value of the voltage value of the high-frequency signal output from the transformer 1-1 161 may be 50V.

According to an example, by adjusting the high-frequency AC voltage through transformer 1-1 161 and transformer 1-2 221, an electric signal having a high voltage may be transmitted to the OC cable 1′. For this reason, the overall thickness of the OC cable 1′ may be kept thin.

According to an example, the first transformer 1-1 161 and the transformer 1-2 221 may control the voltage level of the high-frequency AC signal without a separate component (e.g., a DC-DC converter) for adjusting the voltage of the DC signal, thereby providing a reduced thickness of the power supply device 10 and the display device 20.

According to an example, the transformer 1-1 161 and the transformer 1-2 221 may control the voltage level of the high-frequency AC signal, thereby providing a reduced total thickness of the OC cable 1′.

FIG. 8 is a graph illustrating a voltage and a current over time, measured at a point of an electronic device (e.g., the electronic device 1 of FIG. 5) according to an embodiment of the disclosure over time.

FIG. 8 illustrates a graph (a) showing the voltage V₃₋₄ between the points P₃ and P₄ in the power supply unit 100-1 of FIG. 6, a graph (b) showing the voltage V₅₋₆ between the points P₅ and P₆, and a graph (c) showing the voltage V₇₋₈ between the points P₇ and P₈, a graph (d) showing the current A₁ flowing through the conducting line connecting the points P₇ and P₉ and the current A₂ flowing through the conducting line connecting the points P₈ and P₁₀, and a graph (e) showing the current A₃ flowing through the conducting line connecting the points P₉ and P₁₁ and the current A₄ flowing through the conducting line connecting the points P₁₀ and P₁₂. The unit of the shown voltage value is V (volt), and the unit of the current value is A (ampere). The shown value is merely an example for convenience of description, and may vary according to the type of electrical component applied to the electronic device 1.

According to an example, (a) is a graph illustrating the voltage over time before passing through a filter circuit (e.g., the filter circuit 140-1 of FIG. 6). The maximum value of the voltage value of the electrical signal input to the filter circuit 140-1 may be, e.g., 400V. The waveform of the voltage may be a signal in which AC signals having a plurality of frequencies overlap. As a result, if the vicinity of the peak 810a of the waveform is enlarged, the waveform may not appear as a complete sine wave.

According to an example, (b) is a graph illustrating the voltage over time after the electrical signal having the waveform (a) passes through the filter circuit 140-1. The maximum value of the voltage value of the electrical signal output from the filter circuit 140-1 may be, e.g., 400V. The electrical signal passing through the filter circuit 140-1 may be a signal that is an AC signal having one frequency. The AC signal passing through the filter circuit 140-1 may be an AC signal having a high frequency (e.g., 100 kHz). Thus, if the peak vicinity 810b of the waveform is enlarged, the waveform may appear in the form of a sinusoidal wave. The electrical signal having the waveform of (b) may be input to the transformer 2-1 (e.g., the transformer 2-2 161-1 of FIG. 4). By providing the filter circuit 140-1, it is possible to reduce EMI generated from the alternating current electric signal. By providing the filter circuit 140-1, it is possible to reduce noise generated due to the common mode.

According to an example, (c) is a graph illustrating the voltage over time after an electrical signal having a waveform of (b) passes through the transformer 2-2 161-1. If the vicinity 810c of the peak of the waveform is enlarged, the waveform may appear in the form of a sinusoidal wave. The maximum value of the voltage value of the high-frequency signal output from the transformer 2-2 161-1 may be, e.g., 100V. The maximum value may be derived through the ratio of the number Nₑ of turns of the primary winding and the number N_{f} of turns of the secondary winding of the transformer 2-2 161-1. For example, when Nₑ:N_{f} is 4:1, the maximum value of the voltage value of the high-frequency signal output from the transformer 2-2 161-1 may be 100V. The high-frequency signal output from the transformer 2-2 161-1 may be transferred to the current doubler rectifier (e.g., the current doubler rectifier 240 of FIG. 6) of the power reception unit 200. As the voltage of the high-frequency signal output by the transformer 2-2 161-1 increases, the thickness of the cable 1-2 (e.g., the cable 1-2 1₁₂ of FIG. 4) may be maintained thinner. As a result, the thickness of the OC cable (e.g., the OC cable 1″ of FIG. 5) may be decreased.

According to an example, the first transformer 1-1 161-1 and the transformer 1-2 221-1 may control the voltage level of the high-frequency AC signal without a separate component (e.g., a DC-DC converter) for adjusting the voltage of the DC signal, thereby providing a reduced thickness of the power supply device 10 and the display device 20.

According to an example, the transformer 1-1 161-1 and the transformer 1-2 221-1 may control the voltage level of the high-frequency AC signal, thereby providing a reduced total thickness of the OC cable 1′.

According to an example, (d) is a graph illustrating the waveform of the current A₁ flowing through the conducting line connecting the points P₇ and P₉ and the current A₂ flowing through the conducting line connecting the points P₈ and P₁₀. The waveforms of the current A₁ and the current A₂ may have a sinusoidal waveform. The phase difference between the current A₁ and the current A₂ may be 180° (x).

According to an example, (e) is a graph illustrating the current A₃ flowing through the conducting line connecting the points P₉ and P₁₁ and the current A₄ flowing through the conducting line connecting the points P₁₀ and P₁₂.

According to an example, the current i₁ of A₋₃ may be derived as the sum of the current i₁₁ of A₁ and the current i₁₂ flowing through the conducting line connecting the points P₁₄ and P₉. For example, i₁₂ may be a current after the current passing through the inductor 2-3 246 sequentially passes through the electrolytic condenser 248 and the switching element 2-5 243. The waveform of A₃ may have a shape of a triangular wave as the sum of the sinusoidal wave i₁₁ and the triangular wave i₁₂.

For example, the current i₂ of A₋₄ may be derived as the sum of the current i₂₁ of A₂ and the current i₂₂ flowing through the conducting line connecting the points P₁₆ and P₁₀. For example, i₂₂ may be a current after the current passing through the inductor 2-4 247 sequentially passes through the electrolytic condenser 248 and the switching element 2-6 245. The waveform of A₄ may have a shape of a triangular wave as the sum of the sinusoidal wave i₂₁ and the triangular wave i₂₂.

According to an example, the waveform of the current passing through the inductor 2-3 246 or the inductor 2-4 247 may have a shape of a triangular wave. The current passing through the inductor 2-3 246 or the inductor 2-4 247 may operate alternately. Accordingly, the ripple component generated at the final load end may be decreased. By reducing the ripple component, the allowable capacity of the electrolytic condenser 248 provided at the output end of the current doubler rectifier 240 may be lowered, thereby reducing the amount of the condenser applied to the current doubler rectifier 240.

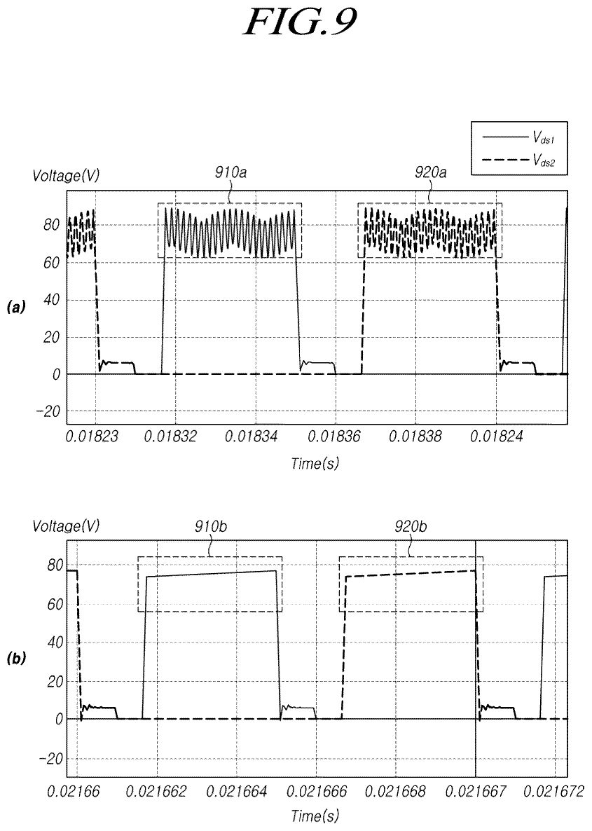

FIG. 9 is a graph illustrating a voltage measured, over time, at a point of an electronic device (e.g., the electronic device 1 of FIG. 5) according to an embodiment of the disclosure.

FIG. 9 illustrates the voltage between the drain end and the source end of the switching element (e.g., the switching element 2-5 243 and the switching element 2-6 245 of FIG. 6) according to the presence or absence of a snubber circuit (e.g., the snubber circuit 250 of FIG. 6) on the current doubler rectifier (e.g., the current doubler rectifier 240 of FIG. 6) in the power reception unit (e.g., the power reception unit 200-1 of FIG. 5). (a) shows the voltage between the drain end and the source end of the switching element 243, 245 when there is no snubber circuit 250, and (b) shows the voltage between the drain end and the source end of the switching element 243, 245 when there is a snubber circuit 250.

According to an example, V_{ds1} is the value obtained by measuring the voltage between the point P₁₄ and the point P₁₅ to measure the voltage between the drain end and source end of the switching element 2-5 243, and V_{ds2} is the value obtained by measuring the voltage between the point P₁₆ and the point P₁₇ to measure the voltage between the drain end and source end of the switching element 2-6 245. Since V_{ds1} and V_{ds2} correspond to voltages having a predetermined phase difference, the following description is based on a waveform of V_{ds1}.

According to an example, in (a), a ringing phenomenon may occur in the vicinity 910a of the voltage peak of V_{ds1} and the vicinity 920a of the voltage peak of V_{ds2}. An inductance component may occur in the conducting line due to high-frequency alternating current transmission, and the ringing phenomenon may occur due to mutual resonance with the parasitic capacitor component present at the drain and source ends of the switching element 243, 245 of the current doubler rectifier 240. The ringing phenomenon may occur after the switch of the switching element 243, 245 is turned off.

According to an example, in (b), it may be identified that the ringing phenomenon in the vicinity 910b of the voltage peak of V_{ds1} and the vicinity 920b of the voltage peak of V_{ds2} is removed. By applying the snubber circuit 250 to the current doubler rectifier 240, the ringing phenomenon may be removed. For example, the snubber circuit 250 may be implemented as a lossless active snubber. The snubber circuit 250 may include a passive element such as a capacitor.

An electronic device 1 according to an embodiment of the disclosure may comprise a power supply device 10 configured to output a high-frequency alternating current through a cable 1′ using an input alternating current 13, and a display 20 configured to operate by a direct current obtained from the high-frequency alternating current supplied from the power supply device 10 through the cable 1′. The power supply device 10 may include a balanced type filter 140 configured to pass the high-frequency alternating current of a single frequency from the input alternating current 13, and a first transformer 160 configured to increase a strength (e.g. voltage) of the high-frequency alternating current that has passed through the balanced type filter 140 and output the high-frequency alternating current through the cable 1′. The display 20 may include a second transformer 220 configured to reduce the high-frequency alternating current supplied through the cable 1′ to a predetermined level and output the high-frequency alternating current, and a rectifier 230 configured to convert the high-frequency alternating current, whose strength (e.g. voltage) has been reduced to the predetermined level by the second transformer 220, into a direct current of a strength (e.g. voltage) for supplying an operating voltage of a target level to an internal circuit.

The electronic device 1 according to an embodiment of the disclosure may comprise an inverter 130 configured to convert a direct current generated from the alternating current supplied from the input alternating current 13 into an alternating current and transfer the input alternating current to the balanced type filter 140.

In the electronic device 1 according to an embodiment of the disclosure, the inverter 130 may include a plurality of switching elements 133, 135 connected to be alternately switched.

In the electronic device 1 according to an embodiment of the disclosure, the balanced type filter 140 may be configured as a notch filter having a time constant by reactance L and capacitance C, so that a switching frequency for resonance becomes a single frequency.

In the electronic device 1 according to an embodiment of the disclosure, the balanced type filter 140 may have a symmetrical structure in which a first inductor 141 and a first capacitor 142 are connected in series to have the time constant during a positive cycle of the input alternating current, and a second inductor 143 and a second capacitor 144 are connected in series to have the time constant during a negative cycle of the input alternating current.

In the electronic device 1 according to an embodiment of the disclosure, a winding ratio Nₐ:N_{b} of the first transformer 160 may be determined considering a strength (e.g. voltage) of the high-frequency alternating current to be supplied to the display 20 through the cable 1′.

In the electronic device 1 according to an embodiment of the disclosure, a winding ratio N_{c}:Nₐ of the second transformer 220 is determined considering the operating voltage to be supplied to the internal circuit.

In the electronic device 1 according to an embodiment of the disclosure, the power supply device 10 may include an external connector interface 11. The cable 1′ may include a power line 1₁₁ for transferring the high-frequency alternating current and a signal line 1₁₂ connecting the external connector interface.

In the electronic device 1 according to an embodiment of the disclosure, the rectifier 230 may be a center-tapped rectifier.

An electronic device 1 according to an embodiment of the disclosure may comprise a power supply device 10 configured to output a high-frequency alternating current through a cable 1″ using an input alternating current 13, and a display 20 configured to operate by a direct current obtained from the high-frequency alternating current supplied from the power supply device 10 through the cable 1″. The power supply device 10 may include a balanced type filter 140-1 configured to pass the high-frequency alternating current of a single frequency from the input alternating current 13, and a transformer 160-1 configured to increase a strength (e.g. voltage) of the high-frequency alternating current that has passed through the balanced type filter 140-1 and output the high-frequency alternating current through the cable 1″. The display 20 may include a current doubler rectifier 240 configured to double a current of the high-frequency alternating current supplied through the cable 1″ to obtain an operating voltage to be supplied to an internal circuit.

The electronic device 1 according to an embodiment of the disclosure may include an inverter 130-1 configured to convert a direct current generated from the input alternating current 13 into an alternating current and transfer the input alternating current to the balanced type filter 140-1.

In the electronic device 1 according to an embodiment of the disclosure, the inverter 130-1 may be configured as a phase shift full bridge (PSFB).

The electronic device 1 according to an embodiment of the disclosure may comprise a coupled inductor 145-1 connected to an output end of the balanced type filter 140-1 to remove noise generated from the balanced type filter 140-1.

In the electronic device 1 according to an embodiment of the disclosure, the coupled inductor 145-1 may be configured in the same winding direction.

In the electronic device 1 according to an embodiment of the disclosure, the rectifier circuit 240 may include at least one inductor 246, 247 disposed to connect an input terminal of the high-frequency alternating current supplied through the cable 1″ and a supply end of the operating voltage in series.

In the electronic device 1 according to an embodiment of the disclosure, the rectifier circuit 240 may include a snubber circuit 250.

In the electronic device 1 according to an embodiment of the disclosure, the snubber circuit 250 may be a lossless active snubber connected to the at least one inductor 246, 247.

In the electronic device 1 according to an embodiment of the disclosure, one end of the snubber circuit 250 may be connected to an output end of a switching element 243, 245. The output end of the switching element 243, 245 may be connected to an input end of the inductor 246, 247.

In the electronic device 1 according to an embodiment of the disclosure, when the voltage across the switch element 243, 245 is a threshold level or more, an electrical signal may be output from the snubber circuit 250.

In the electronic device 1 according to an embodiment of the disclosure, the power supply device 10 may include an external connector interface 11. The cable 1″ may include a power line 1₁₂ for transferring the high-frequency alternating current and a signal line 1₂₂ connecting the external connector interface 11.

According to an embodiment of the disclosure, the electronic device 1 may control the high-frequency alternating signal into a high voltage and transmit the same. As the electronic device 1 transmits the high-voltage, high-frequency alternating current signal, it is possible to implement a reduced thickness of the cable 1 line and the display 20 included in the electronic device 1.

According to an embodiment of the disclosure, user convenience may be increased by implementing a reduced thickness of the cable 1 line and the display 20 included in the electronic device 1.

According to an embodiment of the disclosure, the electronic device 1 may minimize electromagnetic interference (EMI) that may occur due to transmission of a high-frequency AC signal.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used herein, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., a program) including one or more instructions that are stored in a storage medium (e.g., internal memory or external memory) that is readable by a machine. For example, a processor of the machine may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The storage medium readable by the machine may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program products may be traded as commodities between sellers and buyers. The computer program product may be distributed in the form of a machine-readable storage medium (e.g., compact disc read only memory (CD-ROM)), or be distributed (e.g., downloaded or uploaded) online via an application store (e.g., Play Store™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities. Some of the plurality of entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

What is claimed is:

1. An electronic device comprising:
a power supply device configured to output a high-frequency alternating current through a cable based on an input alternating current; and
a display configured to operate based on a direct current obtained from the high-frequency alternating current supplied from the power supply device through the cable,
wherein the power supply device includes:
a balanced type filter configured to pass a high-frequency alternating current having a single frequency from the input alternating current; and
a first transformer configured to increase a voltage of the high-frequency alternating current that has passed through the balanced type filter and to output the high-frequency alternating current having the increased voltage through the cable, and
wherein the display includes:
a second transformer configured to reduce the increased voltage of the high-frequency alternating current supplied from the cable to a predetermined level, and to output the high-frequency alternating current having the reduced voltage; and
a rectifier configured to convert the high-frequency alternating current having the reduced voltage into the direct current of a target level of an operating voltage in an internal circuit.

2. The electronic device of claim 1, further comprising:
an inverter configured to convert a direct current generated from the input alternating current into an alternating current and to transfer the alternating current to the balanced type filter,
wherein the inverter includes a plurality of switching elements connected to be alternately switched.

3. The electronic device of claim 1, wherein the balanced type filter is configured as a notch filter having a time constant based on reactance and capacitance such that a switching frequency for resonance becomes a single frequency.

4. The electronic device of claim 3, wherein the balanced type filter has a symmetrical structure in which:
a first inductor and a first capacitor are connected in series to have the time constant during a positive cycle of the input alternating current, and
a second inductor and a second capacitor are connected in series to have the time constant during a negative cycle of the input alternating current.

5. The electronic device of claim 1, wherein a winding ratio of the first transformer is determined based on a voltage of the high-frequency alternating current to be supplied to the display through the cable, and
wherein a winding ratio of the second transformer is determined based on the operating voltage in the internal circuit.

6. The electronic device of claim 1, wherein the power supply further includes an external connector interface, and
wherein the cable includes a power line configured to transfer the high-frequency alternating current and a signal line configured to connect the external connector interface.

7. The electronic device of claim 1, wherein the rectifier is configured as a center-tapped rectifier.

8. An electronic device comprising:
a power supply device configured to output a high-frequency alternating current through a cable based on an input alternating current; and
a display configured to operate based on a direct current obtained from the high-frequency alternating current supplied from the power supply device through the cable,
wherein the power supply device comprises:
a balanced type filter configured to pass a high-frequency alternating current having a single frequency from the input alternating current; and
a transformer configured to increase a voltage of the high-frequency alternating current that has passed through the balanced type filter and to output the high-frequency alternating current having the increased voltage through the cable, and
wherein the display includes a current doubler rectifier configured to double a current of the high-frequency alternating current having the increased voltage supplied from the cable to obtain an operating voltage in an internal circuit.

9. The electronic device of claim 8, further comprising:
an inverter configured to convert a direct current generated from the input alternating current into an alternating current and to transfer the alternating current to the balanced type filter,
wherein the inverter is configured as a phase shift full bridge.

10. The electronic device of claim 8, further comprising:
a coupled inductor configured to connect to an output end of the balanced type filter and to remove noise generated from the balanced type filter.

11. The electronic device of claim 10, wherein the coupled inductor is configured in a same winding direction.

12. The electronic device of claim 8, wherein the current doubler rectifier further includes:
at least one inductor disposed to connect an input terminal of the high-frequency alternating current supplied from the cable and a supply end of the operating voltage in series.

13. The electronic device of claim 8, wherein current doubler rectifier further includes a snubber circuit, and
wherein the snubber circuit is configured as a lossless active snubber connected to the at least one inductor.

14. The electronic device of claim 13,
wherein one end of the snubber circuit is configured to connect to an output end of a switching element,
wherein the output end of the switching element is connected to an input end of the inductor, and
wherein based on a voltage across the switching element exceeding a threshold level, the snubber circuit is configured to output an electrical signal.

15. The electronic device of claim 8, wherein the power supply device further includes:
an external connector interface, and
wherein the cable includes a power line configured to transfer the high-frequency alternating current and a signal line configured to connect the external connector interface.
